(19) United States
(12) Patent Application Publication
(10) Pub. No.: US 2006/0042422 A1
(43) Pub. Date: Mar. 2, 2006

(54) Broken key extractor

(76) Inventor: George A. Blake, High Point, NC (US)

Correspondence Address: MACCORD MASON PLLC, 300 N. GREENE STREET, SUITE 1600, P. O. BOX 2974, GREENSBORO, NC, 27402, US

(21) Appl. No.: 10/928,360

(22) Filed: Aug. 27, 2004

(51) Int. Cl. B25B 27/00; B23P 19/00; E05B 19/20

(52) U.S. Cl. 81/15.9; 29/270; 29/426.5

(57) ABSTRACT

A handle for holding a tool piece comprising: a fore end region and an aft end region; an edge at the fore end region of the handle defining an opening for inserting a tool piece; and a clamp connected to the fore end region of the handle comprising a pair of selectively movable, substantially diametrically opposed arms. A handle for a broken key extractor, the handle capable of holding a selectively removable 0.050-inch broken key extractor blade such that a tensile force of at least about 50 pounds is required to remove the blade from the handle using a SCOTT J Model Tensile Tester.

### BACKGROUND OF THE INVENTION

(1) Field of the Invention

The present invention relates generally to tools having a handle and a clamp for holding a tool piece and, more specifically, to an improved clamp for holding a tool piece. The clamp is particularly useful for holding an extractor blade in a broken key extractor.

(2) Description of the Prior Art

When a key breaks off in a lock, a locksmith may use a broken key extractor to remove the broken part of the key from the lock. Key extractors are often inserted into the keyway of a lock to grab and pull the broken portion of a key from a lock. Thus the key extractor works best if it has an adequate tensile strength between the blade and the handle of the extractor.

One solution that has been developed is a broken key extractors designed as one-piece unit, in which a blade for the extractor is permanently connected to the extractor. However, when the blade of a one-piece extractor wears out or separates from the handle, another extractor is needed to remove parts of broken keys.

Another kind of broken key extractor has a removable blade that can be replaced when the blade breaks or wears out. One type of removable blade extractor is known as a “pin vise”, and is shown is FIG. 1. While a pin vise provides the advantage of having a removable blade that can be replaced, the pin vise suffers the disadvantage of decreased tensile strength at the connection between the blade and the handle of the pin vise.

Thus, there remains a need for a new and improved broken key extractor that has a removable and replaceable extractor blade, and has increased tensile strength at the connection between the handle and the removable extractor blade.

### SUMMARY OF THE INVENTION

The present invention is directed to a tool comprising: a handle extending along a longitudinal axis, the handle comprising a fore end region and an aft end region; a removable tool piece connected to the fore end region of the handle; and a clamp for removably connecting the tool piece to the handle, the clamp connected to the fore end region of the handle and comprising opposing arm portions, each opposing arm portion extending transverse the longitudinal axis through a portion of the handle.

The present invention is further directed to a broken key extractor comprising: a handle having a fore end region and an aft end region; a blade-holding aperture having an open end and a base end, the aperture defined by at least a portion of the fore end region of the handle; a pair of setscrews; a channel sized to receive the setscrews, the channel having two open ends defined by the handle, wherein the channel substantially intersects the blade-holding aperture, whereby opposing the pair of set screws in the channel creates a clamp; and an extractor blade for gripping broken keys, the blade sized to be received by the open end of the blade-holding aperture and sized to rest on the base end of the blade-holding aperture, wherein the blade is held in place by the pair of opposing set screws.

The present invention is further directed to a broken key extractor comprising: a handle having a fore end region and an aft end region; a blade-holding aperture having an open end and a base end, the aperture defined by at least a portion of the fore end region of the handle; a pair of diametrically opposed rods; an interior wall defining a channel in the fore end region of the handle, the channel for receiving the pair of diametrically opposed rods, the channel substantially intersecting the blade-holding aperture and having two open ends defined by the handle, whereby diametrically opposing the pair rods in the channel creates a clamp for holding an extractor blade; and an extractor blade for gripping broken keys, the blade sized to be received by the open end of the blade-holding aperture and rest on the base end of the blade-holding aperture, wherein the blade is held in place by the pair of diametrically opposed rods.

The present invention is further directed to a handle for holding a tool piece comprising: a fore end region and an aft end region; an edge at the fore end region of the handle defining an opening for inserting a tool piece; and a clamp connected to the fore end region of the handle comprising a pair of selectively movable, substantially diametrically opposed arms.

The present invention is further directed to a handle for a broken key extractor comprising: a fore end region and an aft end region; an edge in the fore end region of the handle defining an opening for inserting an extractor blade; and a clamp connected to the fore end region of the handle comprising a pair of arms substantially diametrically opposed along a clamp axis, each arm movable along the axis toward the opposing arm.

The present invention is further directed to a blade holder for a broken key extractor comprising: a handle disposed along a longitudinal axis, the handle comprising a fore end region and an aft end region; an edge in the fore end region of the handle defining an opening for inserting a blade; and a substantially cylindrical wall defining a channel extending substantially transverse the longitudinal axis of the handle.

The present invention is further directed to a broken key extractor comprising: a handle having a fore end region, wherein the handle fore end region at least partially defines a blade-holding aperture; a pair of substantially diametrically opposed rods; an interior wall defining a channel for receiving the pair of substantially diametrically opposed rods; and an extractor blade for gripping broken keys, the blade sized to be received by the blade-holding aperture.

The present invention is further directed to a clamp for connecting a tool piece to a handle, the clamp comprising: at least two arms at least partially defining an aperture having at least one open end, the aperture at least partially within the handle, each arm selectively movable toward the aperture at least partially defined by the arms; and an interior wall within the handle at least partially defining the space for inserting the tool piece.

The present invention is further directed to a broken key extractor comprising a handle and a selectively removable 0.050-inch extractor blade wherein a tensile force of at least about 50 pounds is required to remove the blade from the handle using a SCOTT J Model Tensile Tester.

The present invention is further directed to a handle for a broken key extractor, the handle capable of holding a selectively removable 0.050-inch broken key extractor blade such that a tensile force of at least about 50 pounds is required to remove the blade from the handle using a SCOTT J Model Tensile Tester.

### BRIEF DESCRIPTION OF THE DRAWINGS

FIG. 1 is a perspective view of a prior art pin vise broken key extractor;

FIG. 2 is a perspective view of a broken key extractor constructed according to the present invention; and

FIG. 3 is a side view of an embodiment of a broken key extractor adapted to include a light.

### DESCRIPTION OF THE PREFERRED EMBODIMENTS

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

Referring now to the drawings in general and FIG. 2 in particular, the illustrations are for the purpose of describing preferred embodiments of the invention and are not intended to limit the invention thereto. FIG. 2 shows a broken key extractor, generally designated 10, constructed according to the present invention. The broken key extractor 10 includes a blade holder 12 comprising a handle 14. In the embodiment shown, the broken key extractor 10 further comprises a clamp 16 for removably connecting an extractor blade 20 to the handle 14. The broken key extractor 10 may further include a blade-holding aperture 22. In the embodiment shown, the broken key extractor 10 further includes a channel 24 defined by a wall 26 extending through the handle 14 of the extractor 10. The extractor 10 may further comprise a removable extractor blade 20 for gripping broken keys.

In the embodiment of the invention shown in FIG. 2, the handle 14 for the broken key extractor 10 comprises a fore end region 30 and an aft end region 32. The fore end region 30 of the handle 14 at least partially defines a blade-holding aperture 22. The handle 14 further includes an edge 36 in the fore end region 30 defining an opening 38 for inserting an extractor blade 20. The handle 14 is disposed along a longitudinal axis 40. A surface of the handle may include knurling 42 for increasing the ability of a user to hold and grip the handle 14.

In the embodiment of the invention shown in FIG. 2, the broken key extractor 10 further comprises a clamp 16. The clamp 16 may be connected to the fore end region 30 of the handle 14. The clamp 16 comprises two arm opposing arm portions 50. Each of the opposing arm portions 50 may extend transversely through a portion of the handle 14. At least one of the opposing arm portions 50 may comprise a cylindrical rod. The cylindrical rod may comprise a setscrew. In the embodiment of the invention shown in FIG. 2, the clamp 16 comprises a pair of diametrically opposed rods. The diametrically opposed rods may be selectively movable towards each other along a clamp axis 54. The clamp axis 54 may be perpendicularly disposed with respect to the blade-holding aperture 22 and an inserted extractor blade 20. In the embodiment shown, the diametrically opposed arms 50 are rods having a helical groove on an outer surface. The helical groove corresponds to another helical groove on the surface of the wall 26 at least partially defining a channel 16 through the handle 14 of the extractor. When the arms 50 are opposed in the channel 16 with a portion of an extractor blade 20 inserted into the blade holding aperture 22 there between, the arms 50 may be moved toward one another, which exerts a pair of opposing forces on the extractor blade 20, thereby holding the blade 20 in place for use. The rods 50 may have a substantially planar surface in contact with the extractor blade 20.

In the embodiment shown, the clamp 16 is disposed within the channel 24 in the handle 14 of the key extractor 10. The channel 24 may be defined by a substantially cylindrical wall 26 extending substantially transverse the longitudinal axis 40 of the handle 14. The substantially cylindrical wall 24 may comprise a helical groove on its surface. The channel 24 may substantially perpendicularly intersect the blade-holding aperture 22. The channel 24 may have two open ends 60 defined by the handle 14 and may be sized to receive a pair of opposing setscrews.

In one embodiment, the blade holding aperture 22 comprises an open end 90 and a base end 92. The open end 90 of the aperture 22 may be defined by an edge 36 in the fore end region 30 of the handle 14. The base end 92 may include a wall 96 for positioning an extractor blade.

In the embodiment shown, the broken key extractor 10 further includes a blade storage compartment 72. The blade storage compartment 72 may be completely or partially disposed within the aft end region 32 of the handle 14. The blade storage compartment 72 may be at least partially defined by a wall 76 within the interior of the handle 14 of the extractor 10. The wall 76 at least partially defining the storage compartment 72 may be a cylindrical wall. The extractor 10 may further include an opening for accessing the storage compartment and an end cap for retaining items within the storage compartment.

The broken key extractor 10 may further include the removable extractor blade 20. In the embodiment shown, the extractor blade 20 comprises a barb 80 disposed helically around the blade 20 for gripping a broken key and extracting the broken key from a lock. The extractor blade 20 may be a 0.040-inch or 0.050-inch diameter blade available from HPC, Inc., 3999 N. 25th Avenue, Schiller Park, Ill. 60176 USA. The extractor blade 20 may extend longitudinally in substantially the same direction as axis 40 of the handle 14, but the invention can be practiced with handle axis 40 and the longitudinal extension of the extrusion blade 20 substantially perpendicularly disposed with respect to one another, or at any other desired angle with respect to each other.

FIG. 3 is a side view of an embodiment of the broken key extractor 10 adapted to include a light. The extractor 10 includes a light source 112, an adaptor 114 for connecting the light source 112 to the extractor 10 and a pathway 116 for transmitting light from the light source 112 through the extractor 10. In one embodiment, the pathway 116 houses a fiber optic tube 118. The light source 114 may be an ordinary flashlight.

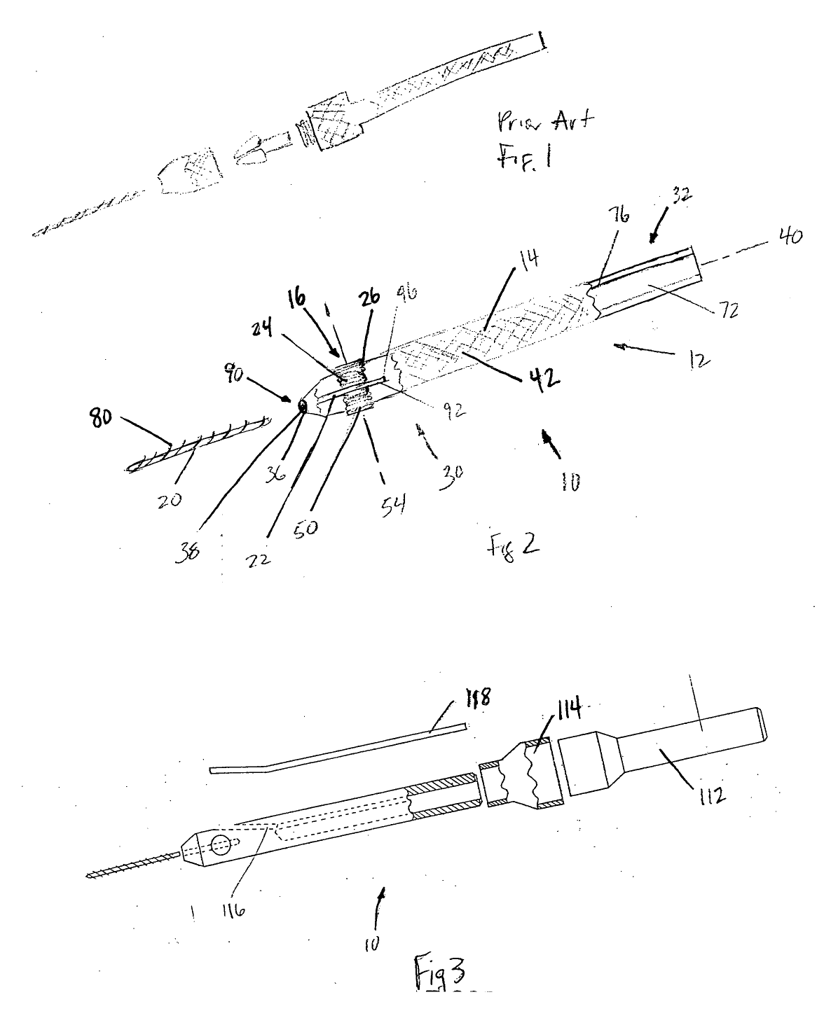

A series of two tests were conducted to determine the tensile strength of the broken key extractor described herein as compared to the prior art pin vise shown in FIG. 1. Both tests were conducted using a SCOTT J Model Tensile Tester. A 0.050-inch conventional extractor blade, available from HPC, Inc., 3999 N. 25th Avenue, Schiller Park, Ill. 60176 USA, was inserted into the pin vise, and the front of the pin vise tightened using two pairs of pliers—one pair holding the handle of the pin vise and the other turning the head to tighten the clamp of the pin vise. A force equaling about 32 pounds was required to break the extractor blade from the clamp of the pin vise. An extractor blade was thereafter inserted into the clamp of the broken key extractor of the present invention and tightened therein using a standard Allen wrench. Under these conditions, a force of 101 pounds was required to separate the blade from the clamp of the present invention.

While the preferred embodiment of the invention is described herein as a broken key extractor, the invention is not limited to such use. For example, other embodiments of the invention include an awl or other device for punching holes in leather or other articles. In this embodiment, a sharp rod or needle can be inserted into the handle of the invention. Similarly, the invention may also be used as a reamer for reaming holes, or a wire or other bit may be inserted into the handle of the invention so a locksmith can use it to work upon a lock or latch of a door. In addition, a drill bit can be inserted into the handle for boring holes. These embodiments, and others, are within the scope of the following claims.

Certain modifications and improvements may occur to those skilled in the art upon a reading of the foregoing description. All such modifications and improvements have been deleted herein for the sake of conciseness and readability but are properly within the scope of the following claims.

We claim:

1. A tool comprising:
(a) a handle extending along a longitudinal axis, the handle comprising a fore end region and an aft end region;
(b) a removable tool piece connected to the fore end region of the handle; and
(c) a clamp for removably connecting the tool piece to the handle, the clamp connected to the fore end region of the handle and comprising opposing arm portions, each opposing arm portion extending transverse the longitudinal axis through a portion of the handle.

2. The tool according to claim 1, wherein at least one of the opposing arm portions comprises a cylindrical rod.

3. The tool according to claim 2, wherein the cylindrical rod comprises a setscrew.

4. The tool according to claim 1, further comprising knurling on the surface of the handle.

5. The tool according to claim 1, further including an interior wall at least partially defining a storage compartment within the handle.

6. A broken key extractor comprising:
(a) a handle having a fore end region and an aft end region;
(b) a blade-holding aperture having an open end and a base end, the aperture defined by at least a portion of the fore end region of the handle;
(c) a pair of setscrews;
(d) a channel sized to receive the setscrews, the channel having two open ends defined by the handle, wherein the channel substantially intersects the blade-holding aperture, whereby opposing the pair of set screws in the channel creates a clamp; and
(e) an extractor blade for gripping broken keys, the blade sized to be received by the open end of the blade-holding aperture and sized to rest on the base end of the blade-holding aperture, wherein the blade is held in place by the pair of opposing set screws.

7. The broken key extractor according to claim 6, wherein the blade-holding aperture is disposed longitudinally and the channel substantially intersects the blade-holding aperture substantially perpendicularly.

8. The broken key extractor according to claim 6, further including knurling on the surface of the handle.

9. The broken key extractor according to claim 6, further including an interior wall at least partially defining a blade storage compartment in the handle.

10. A broken key extractor comprising:
(a) a handle having a fore end region and an aft end region;
(b) a blade-holding aperture having an open end and a base end, the aperture defined by at least a portion of the fore end region of the handle;
(c) a pair of diametrically opposed rods;
(d) an interior wall defining a channel in the fore end region of the handle, the channel for receiving the pair of diametrically opposed rods, the channel substantially intersecting the blade-holding aperture and having two open ends defined by the handle, whereby diametrically opposing the pair rods in the channel creates a clamp for holding an extractor blade; and
(e) an extractor blade for gripping broken keys, the blade sized to be received by the open end of the blade-holding aperture and rest on the base end of the blade-holding aperture, wherein the blade is held in place by the pair of diametrically opposed rods.

11. The broken key extractor according to claim 10, wherein each diametrically opposed rods comprises a setscrew.

12. The apparatus according to claim 10, further including an interior wall at least partially defining a storage compartment in the interior of the handle, the storage compartment extending into the aft end region of the handle.

13. The broken key extractor according to claim 10, wherein the interior wall defining the channel comprises a helical groove for inserting a pair of setscrews.

14. The broken key extractor according to claim 10, wherein the handle comprises knurling on at least a portion of its outer surface.

15. A handle for holding a tool piece comprising:
(a) a fore end region and an aft end region;
(b) an edge at the fore end region of the handle defining an opening for inserting a tool piece; and
(c) a clamp connected to the fore end region of the handle comprising a pair of selectively movable, substantially diametrically opposed arms.

16. The handle according to claim 15, wherein the arms extend substantially through the fore end region of the handle.

17. The handle according to claim 15, wherein each arm comprises a setscrew.

18. The handle according to claim 15, wherein at least a portion of the fore end region comprises knurling on its outer surface.

19. The handle according to claim 15, wherein at least a portion of the aft end region comprises knurling on its outer surface.

20. A handle for a broken key extractor comprising:
(a) a fore end region and an aft end region;
(b) an edge in the fore end region of the handle defining an opening for inserting an extractor blade; and
(c) a clamp connected to the fore end region of the handle comprising a pair of arms substantially diametrically opposed along a clamp axis, each arm movable along the axis toward the opposing arm.

21. The handle according to claim 20, wherein each arm comprises a cylindrical rod.

22. The handle according to claim 20, wherein the clamp arms are perpendicularly disposed with respect to an inserted extractor blade.

23. The handle according to claim 20, further including an interior wall defining a space in the handle.

24. A blade holder for a broken key extractor comprising:
(a) a handle disposed along a longitudinal axis, the handle comprising a fore end region and an aft end region;
(b) an edge in the fore end region of the handle defining an opening for inserting a blade; and
(c) a substantially cylindrical wall defining a channel extending substantially transverse the longitudinal axis of the handle.

25. The blade holder according to claim 24, wherein the cylindrical wall comprises a helical groove.

26. The blade holder according to claim 24, further comprising a clamp for holding the blade.

27. The blade holder according to claim 26, wherein the clamp is at least partially disposed within the channel.

28. The blade holder according to claim 27, wherein the clamp comprises at least one rod.

29. The blade holder according to claim 28, wherein the clamp comprises an additional rod.

30. The blade holder according to claim 29, wherein each rod includes a helical groove on its surface.

31. A broken key extractor comprising:
(a) a handle having a fore end region, wherein the handle fore end region at least partially defines a blade-holding aperture;
(b) a pair of substantially diametrically opposed rods;
(c) an interior wall defining a channel for receiving the pair of substantially diametrically opposed rods; and
(d) an extractor blade for gripping broken keys, the blade sized to be received by the blade-holding aperture.

32. The broken key extractor of claim 31, wherein the blade-holding aperture comprises an open end and a base end.

33. The broken key extractor of claim 32, further including a wall at the base end of the blade-holding aperture.

34. The broken key extractor of claim 31, wherein the channel substantially intersects the blade-holding aperture and has two open ends defined by the handle, whereby opposing the pair of substantially diametrically opposed rods in the channel creates a clamp for holding an extractor blade.

35. The broken key extractor of claim 34, wherein the substantially diametrically opposed rods are set screws.

36. The broken key extractor of claim 31, wherein the extractor blade rests on the base end of the blade-holding aperture, and wherein the blade is held in place by the pair of diametrically opposed rods.

37. A clamp for connecting a tool piece to a handle, the clamp comprising:
(a) at least two arms at least partially defining an aperture having at least one open end, the aperture at least partially within the handle, each arm selectively movable toward the aperture at least partially defined by the arms; and
(b) an interior wall within the handle at least partially defining the space for inserting the tool piece.

38. The clamp according to claim 37, wherein the arms are substantially diametrically opposed.

39. The clamp according to claim 37, wherein each arm comprises a rod.

40. The clamp according to claim 39, further comprising a helical groove on an outer surface of each rod.

41. The clamp according to claim 37, wherein said interior wall is cylindrical.

42. A broken key extractor comprising a handle and a selectively removable 0.050-inch extractor blade wherein a tensile force of at least about 50 pounds is required to remove the blade from the handle using a SCOTT J Model Tensile Tester.

43. The broken key extractor according to claim 42, wherein a force of at least about 75 pounds is required to remove the blade from the handle using a SCOTT J Model Tensile Tester.

44. A handle for a broken key extractor, the handle capable of holding a selectively removable 0.050-inch broken key extractor blade such that a tensile force of at least about 50 pounds is required to remove the blade from the handle using a SCOTT J Model Tensile Tester.

45. The handle according to claim 44, capable of holding a selectively removable 0.050-inch broken key extractor blade such that a tensile force of at least about 50 pounds is required to remove the blade from the handle using a SCOTT J Model Tensile Tester.
